(19) United States
(12) Patent Application Publication
(10) Pub. No.: US 2007/0155499 A1
(43) Pub. Date: Jul. 5, 2007

(54) Game board

(76) Inventor: Marcell Thomas, Brooklyn, NY (US)

Correspondence Address: Law Offices of Alozie N. Etufugh, PLLC, Suite 4D, 30 Central Park South, New York, NY, 10019, US

(21) Appl. No.: 11/303,205

(22) Filed: Dec. 15, 2005

(51) Int. Cl. A63F 13/00

(52) U.S. Cl. 463/37

(57) ABSTRACT

The present invention provides a board game. The board game includes a display screen. A transparency game sheet is disposed above the display screen, where the transparency game sheet includes a plurality of games. A display holder is configured to hold the transparency game sheet on top of the display screen. A writing instrument is disposed next to the display screen. An arm is affixed to the transparency sheet, where the arm is configured to move the transparency sheet over the display screen.

### FIELD OF THE INVENTION

The present invention relates generally to a board game. More specifically, the present invention relates to the apparatus and rules for playing a board game.

### BACKGROUND OF THE INVENTION

Generally, people play board games as a means to interact with each other. Also, people may play board games to pass the time by having entertainment or learning about some aspect of the human experience. In particular, board games can be used by individual players to play various games such as Etch A Sketch®, which is a registered trademark of The Ohio Art Company located at One Toy Street, Bryan, Ohio.

When an individual utilizes Etch a Sketch® device; he may utilize two knobs on their device to draw a picture on a display screen. However, this device does not enable one to play a game on it. Also, more than one person can't play a continuous game on Etch a Sketch®. This type of board game with Etch a Sketch® allows individuals to write anything on the magnetic screen, but it doesn't allow anyone to play games. Nonetheless, if an individual could play a game on the aforementioned device, then the game may be enjoyable and fun.

Therefore, there is a need for a board game with a magnetic screen that is enjoyable, fun and simple to use.

### BRIEF SUMMARY OF THE INVENTION

The present invention has been accomplished in view of the above-mentioned technical background, and it is an object of the present invention to provide an innovative board game.

In a preferred embodiment of the invention a board game is disclosed. The board game includes a display screen. A transparency game sheet is disposed above the display screen, where the transparency game sheet includes a plurality of games. A display holder is configured to hold the transparency game sheet on top of the display screen. A writing instrument is disposed next to the display screen. An arm is affixed to the transparency sheet, where the arm is configured to move the transparency sheet over the display screen.

In another preferred embodiment of the invention, a method for playing a board game is disclosed. The game is initiated. Next, there is a determination of what move to make based on initiating the game. There is a determination if based on the move if the game is finished.

In another preferred embodiment of the invention, a method for playing a board game is disclosed. A game is initiated. A letter in the game is marked off. There is a determination if based on the mark made if the game is finished.

### BRIEF DESCRIPTION OF SEVERAL VIEWS OF THE DRAWINGS

These and other advantages of the present invention will become more apparent as the following description is read in conjunction with the accompanying drawings, wherein:

FIG. 1 illustrates an embodiment of a board game in accordance with the invention;

FIG. 2 depicts an embodiment of a transparency game sheet of FIG. 1 in accordance with the invention;

FIG. 3 is a flow chart that depicts how the board game in FIG. 1 is employed in accordance with the invention;

FIG. 4 illustrates another embodiment of a transparency game sheet of FIG. 1 in accordance with the invention;

FIG. 5 is a flow chart that depicts a method of how the board game of FIG. 4 is utilized in accordance with the invention;

FIG. 6 illustrates yet another embodiment of a transparency game sheet in accordance with the invention; and

FIG. 7 is a flow chart that depicts a method of how the board game of FIG. 6 is employed in accordance with the invention.

### DETAILED DESCRIPTION OF THE INVENTION

The presently preferred embodiments of the invention are described with references to the drawings, where like components are identified with the same numerals. The descriptions of the preferred embodiments are exemplary and are not intended to limit the scope of the invention.

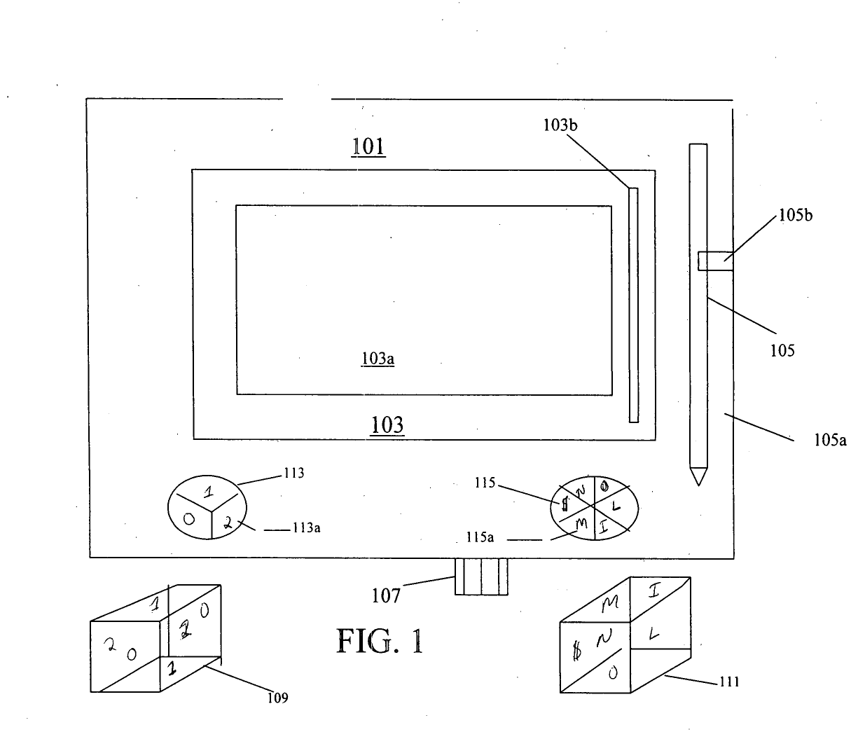

FIG.1 illustrates a board game. The board game 101 includes a display screen 103, a transparency game sheet 103a, a display screen holder structure 104, a writing instrument 105, an arm 107, a first die 109, a second die 111, a first wheel device 113 and a second wheel device 115. Display screen 103 is a typical magnetic screen, such as an Etch-A-Sketch® screen that allows a user with a magnetic pen or writing instrument 105 to physically write information onto the display screen 103. This information written onto the display screen 103 can be erased off the display screen 103 by simply shaking the board game, similar to the Etch-A-Sketch® screen. Also, the written information on display screen 103 can be removed or erased when the arm 107 is moved horizontally across a back portion of display screen 103. Display screen holder structure 104 or display screen holder 104 is affixed by glue or mechanical means to the display screen 103 and board game 101. Display screen holder 104 holds and secures the transparency game sheet on top of the display screen 103. Also, this display screen holder 104 holds the display screen 103 on the board game and has a spacing or small opening 103b between the display screen 103 and display screen holder 104. The space 103b between the display screen holder 104 and display screen 103 is in the range of about 1 mm to 100 mm. Writing instrument 105 may be a magnetic pen or any typical instrument utilized to write on a magnetic display screen. Writing instrument 105 is disposed next to display screen 103 situated in a recess portion 105a of board game 101 where the writing instrument is held in place by an enclosure attachment 105b. This enclosure attachment 105b is flexible and bendable to allow for the placement and removal of the writing instrument 105 from the recess portion 105a.

Display screen 103 is coupled to the board game 101 by the typical mechanical means, such as fastener tabs (not shown), fastening means or glue. The transparency game sheet 103a is located on top of the display screen 103. The arm 107 or rotating arm 107 rotates the transparency game sheet over display screen 103. The rotating arm 107 includes an elongated portion (not shown) where the transparency game sheet 103a is affixed or wrapped around this elongated portion so that a plurality of games on transparency game sheet 103a can be unwrapped and exposed when the rotating arm is turned from 0 degrees to 360 degrees. As the rotating arm 107 turns from 0 degrees to 360 degrees, then transparency game sheet 103a goes through a small opening 103b in display screen 103 in a horizontal manner, while the transparency game sheet 103a is disposed over the display screen 103.

The transparency game sheet 103a allows the players to play a plurality of games, such as three distinctly different games on board game 101. As part of board game 101, first die 109 is similar to a typical die in that it has 6 sides, but first die 109 has only three numbers 0, 1 and 2 depicted on each side of the first die. Similar to die 109, first wheel device 113 also includes three sections that include numbers 0, 1 and 2 so that when a player spins the wheel a typical plastic stopper 113a or spinning flexible tab 113a stops at sections with numbers 0, 1 and 2. The first wheel device 113 is affixed to the display 101 by glue or typical mechanical means. For the second die 111, this die is also similar to a typical die in that it has 6 sides, but this die has the numerals $, M, I, L, O and N depicted on the face of its sides. The second wheel device 115 is similar to second die 111 in that the second wheel device 115 also includes 6 sections that include numerals $, M, I, L, O and N so that when a player spins the wheel a typical plastic stopper 115a or spinning flexible tab 115a will stop at either numerals $, M, I, L, O and N.

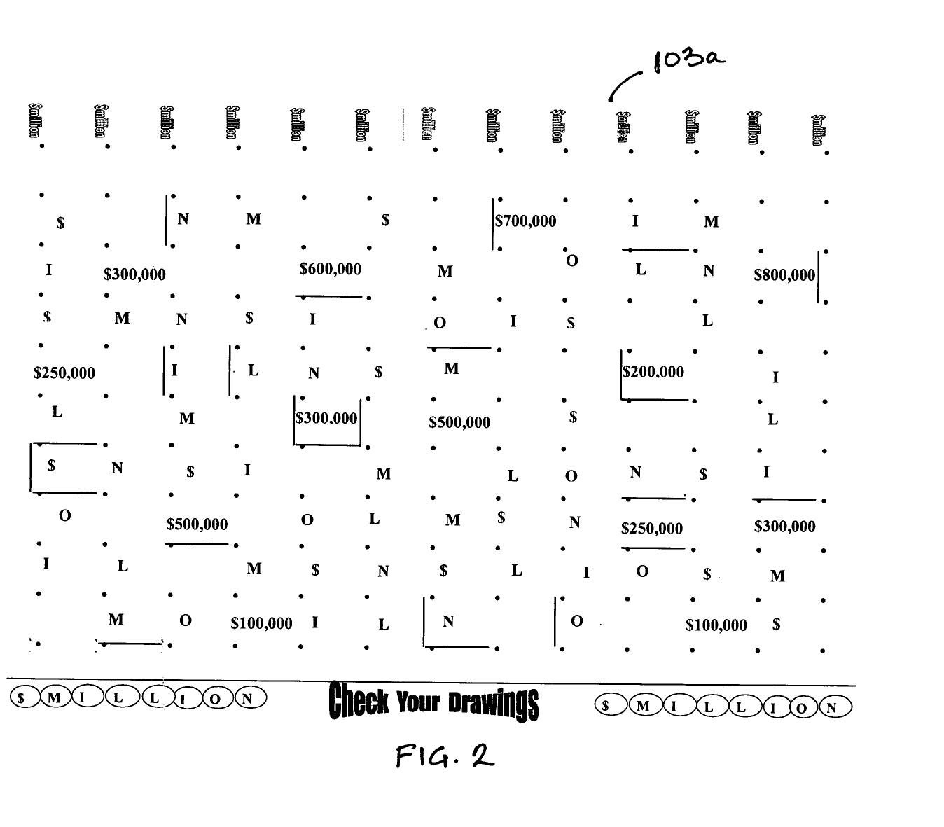

FIG.2 shows an example of a transparency game sheet 103a that can be played on board game 101. In this example, the transparency game sheet 103a includes a plurality of dots, various amounts of money, numerals and vertical depictions of $million. The amounts of money include: $100,000, $250,000, $300,000, $500,000, $700,000 and $800,000. The amounts of money utilized for this example of the transparency game sheet 103 is not limited to the aforementioned money values, but they can also be increased or decreased. For example, the amounts of money such as $100,000 can be increased to $1,000,000 or more and $100,000 can be decreased to $10,000 or less.

Next to the various amounts of money on the transparency game sheet 103a, are the numerals $, M, I, L, O and N. Two or more players can play this game. A player wins this game by being the first player to obtain one million dollars on the transparency game sheet 103a. Even though, this particular game allows the first player with one million to win, the numerical value is not limited to one million, the numerical values can range anywhere from $1.00 to $1 trillion dollars and more depending on the numerical values depicted on the transparency game sheet 103a. For example, the numerical values can be increased from $700,000 or more to $700,000,000 or decreased from $700,000 to $700.00 or less. For this particular game, the first player who can spell the word “$MILLION” by utilizing the writing instrument 105 to trace or write dashed lines to form a box around the numerals M, I, L, O, N and $. Also, the winner may be the first person to utilize the writing instrument 105 to trace or write dashed lines to form a box around the numerical values $100,000, $250,000, $300,000, $500,000 and $750,000 in any combination that adds up to 1 million or more. Further, the winner will be the first person to trace or write dashed lines to form a box around the aforementioned numerical values and trace or write between the plurality of dots until he reaches a vertical depiction of $MILLION.

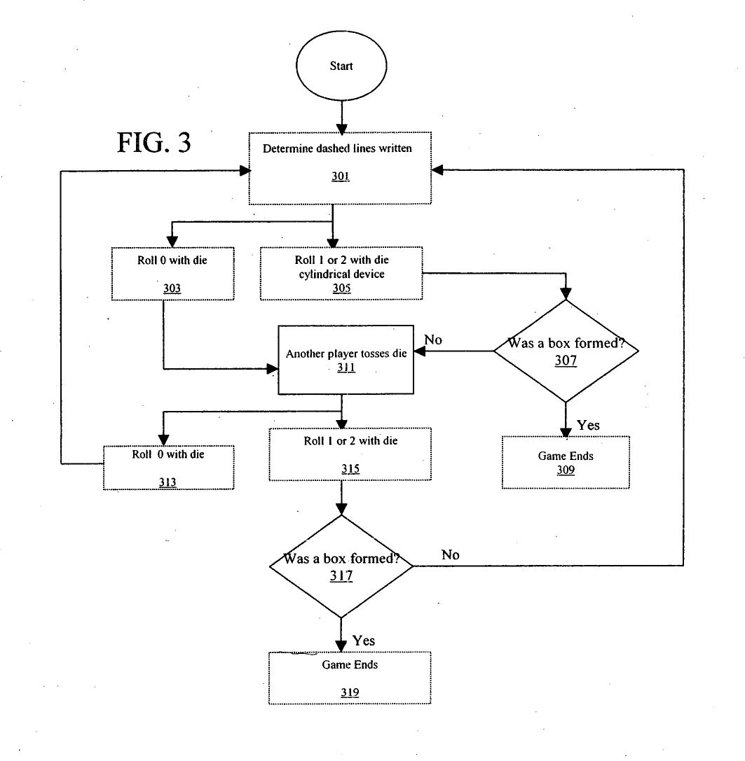

FIG. 3 is a flow chart that shows how the board game may be utilized in one embodiment of the invention. At 301, a first player initiates a game by rolling or tossing the first die 109 (FIG. 1) to determine how many dash lines he can write or trace utilizing writing instrument 105 between the plurality of dots on the transparency game sheet 103a. In an alternative embodiment, the player may spin first wheel device 113 (FIG. 1) to determine the number of dash lines he can trace utilizing the writing instrument 105 between the dots on display screen 103. First spin wheel device 113 may be used interchangeably with first die 109. At 303, the first player may roll a 0 with first die 109 this indicates that t the player doesn't move at all and the second player is allowed to play at 311.

At 305, the first player may roll a 1 or 2 with first die 109, then he may trace 1 or 2 dashed lines by utilizing writing instrument 105, between dots on transparency game sheet 103a horizontally or vertically from anywhere on the first row or last row of horizontal lines depending on where the first player is located in relation to the board game 101. The first player traces the dashes between the lines to form a box around the amounts of money $100,000, $200,000, $250,000, $300,000, $500,000, $600,000 and $800,000 to add up to $1 million to win the game. Also, the first player may trace the dashes between the dots on transparency game sheet 103a to form a box around the numerals $, M, I, L, O and N to form the word $MILLION to win the game. Further, the first player may continue writing or tracing a dot on transparency game sheet 103a by utilizing writing instrument 105 from where he left off at his previous turn.

After the first player utilizes the writing instrument 105 to write the dashed line between the dots on transparency sheet 103a, then there is a determination at 307 if the dashed lines between the dots traced by the writing instrument 105 has formed boxes around amounts of money 100,000, $200,000, $250,000, $300,000, $500,000, $600,000 and $800,000 to add up to $1 million to win the game. Also, there is determination at 307 if the dashed lines between the dots traced by the writing instrument 105 form a box around the numerals $, M, I, L, O and N to form the word $MILLION to win the game. If there is a determination that the boxes formed around the amounts of money $100,000, $200,000, $250,000, $300,000, $500,000, $600,000 and $800,000 add up to $1 million, then the first player wins and the game ends at 309. Alternatively, if the first player forms a box around 1 money value, such as $100,000 and traces or writes between the dots to reach a vertical depiction of $1 million, then the first player wins and the game ends at 309. In yet another alternative, if there is a determination that the boxes formed around the numerals spell $MILLION, then the first player wins the game and the game ends at 309. If the required boxes are not traced or written around the numerals or amounts of money on the transparency games sheet 103a by the writing instrument 105, then the game continues and the second player is allowed to play at 311.

At 311, a second player rolls or tosses the first die 109 to determine how many dashed lines he can write or trace, by utilizing writing instrument 105, between dots on transparency game sheet 103a. In an alternative embodiment, the player may spin first wheel device 113 to determine the number of dash lines he can trace utilizing the writing instrument 105 between the dots on transparency game sheet 103a. At 313, the second player may roll a 0 with first die 109 this indicates that the second player doesn't move at all and the first player is allowed to play at 301.

At 315, the second first player may roll a 1 or 2 with first die 109, then he may trace 1 or 2 dashed lines by utilizing writing instrument 105 between dots on transparency game sheet 103a horizontally or vertically from anywhere on the first row or last row of horizontal lines depending on where the second player is located in relation to the board game 101. The second player traces the dashes between the lines to form a box around the amounts of money $100,000, $200,000, $250,000, $300,000, $500,000, $600,000 and $800,000 to add up to $1 million to win the game. Also, the second player may trace the dashes between the dots to form a box around the numerals $, M, I, L, O and N to form the word $MILLION to win the game.

After the second player utilizes the writing instrument 105 to write the dashed line between the dots on transparency sheet 103a, then there is a determination at 317 if the dashed lines between the dots traced by the writing instrument 105 has formed boxes around amounts of money 100,000, $200,000, $250,000, $300,000, $500,000, $600,000 and $800,000 to add up to. $1 million to win the game. Also, there is determination at 317 if the dashed lines between the dots traced by the writing instrument 105 form a box around the numerals $, M, I, L, O and N to form the word $MILLION to win the game. If there is a determination that the boxes formed around the amounts of money $100,000, $200,000, $250,000, $300,000, $500,000, $600,000 and $800,000 add up to $1 million, then the second player wins and the game ends at 319. Alternatively, if the second player forms a box around a money value, such as $100,000 and traces or writes between the dots to reach a vertical depiction of $1 million, then the second player wins and the game ends at 319. In yet another alternative, if there is a determination that the boxes formed around the numerals spell $MILLION, then the second player wins the game and the game ends at 319. If the required boxes are not traced on the transparency sheet 103a of the writing instrument 105 then the game continues and the first player continues at 301.

When the first or second player is able to complete tracing a box by utilizing writing instrument 105 on transparency sheet 103a, to form boxes around the numbers or numerals $, M, I, L, ON to form the word $1 Million or numbers. $100,000, $200,000, $250,000, $300,000, $500,000 and $800,000 combined to form 1 million then the board game is completed. In another embodiment, the first or second player may include their initials or any mark to indicate they have completed a box in order to keep track of their boxes.

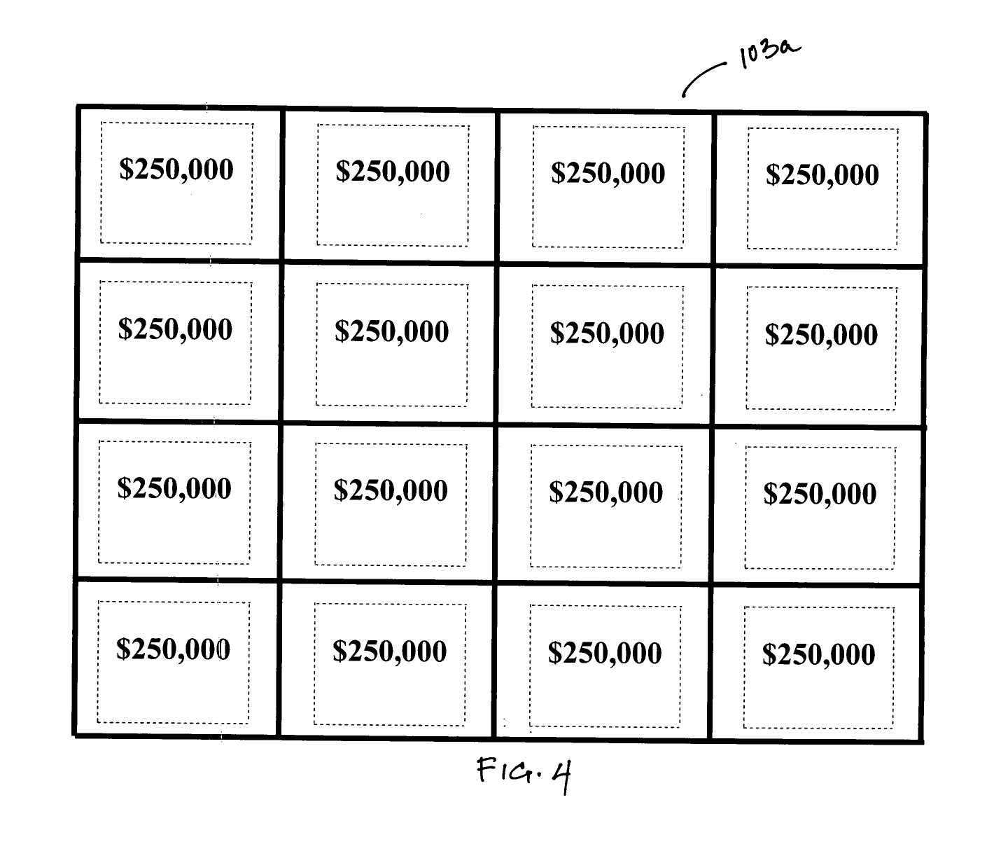

FIG. 4 is another embodiment of a transparency game sheet 103a in accordance with the invention. The rotating arm 107 is utilized to rotate transparency sheet 103a onto display screen 103 through the opening 103b. This transparency game sheet 103a includes 16 boxes that also include a dashed boxed with a numerical money value of $250,000. Even though, this transparency game sheet depicts the numerical money value of $250,000 this, transparency sheet is not limited to this value, for example the numerical value can be increased to $250,000,000 or more or the numerical value can be decreased to $2.50 or less.

For this transparency game sheet 103a, the player employs the writing instrument pen 105 to write or trace between the dots in 1 or 2 strokes to form a box around the numerical value of $250,000. When a player employing the writing instrument pen 105 on transparency game sheet 103a traces four boxes with $250,000, then this player wins the game. Alternatively, if the numerical values are changed in any way then 2 or more boxes may be used to win the game. For example, if $250,000 was replaced with $500,000 and the player writes or traces dashed lines around 2 boxes with the $500,000 wins the game. However, if the numerical value of $250,000 were replaced with $200,000 then the player would need to complete tracing or writing dashed lines around 5 boxes to win the game.

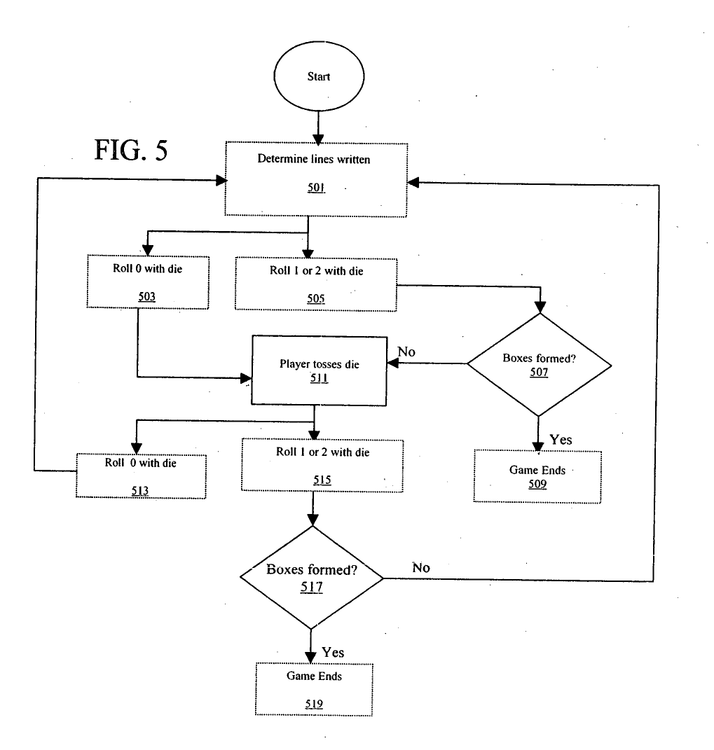

FIG. 5 is a flow chart that shows how the board game of FIG. 4 may be employed in accordance with an embodiment of the invention. At 501, a first player rolls or tosses the first die 109 to determine how many dash lines he can write or trace by utilizing writing instrument 105 to write or trace between plurality of dots on transparency game sheet 103a to form a box around monetary value $250,000. In an alternative embodiment, the player may spin first wheel device 111 to determine the number of dash lines he can trace or write, utilizing the writing instrument 105, between the dots on transparency game sheet 103a. For this embodiment, first die 109 may be used interchangeably with first spin wheel device 113. At 503, the first player may roll a 0 with first die 109 this indicates that the player doesn't move at all and the second player is allowed to play at 511.

At 505, the first player may roll a 1 or 2 with first die 109, then he may trace or write 1 or 2 dashed lines by utilizing writing instrument 105 between dots on transparency game sheet 103a horizontally or vertically from anywhere on the first row or last row of horizontal lines depending on where the first player is located in relation to the board game 101. The first player writes or traces the dashes between the lines to form a box around the amounts of money $250,000 to add up to $1 million to win the game. Even though $250,000 is the only numerical value depicted on this transparency sheet 103a, but this embodiment is not limited to this value. For example, the numerical value of $250,000 may be decreased to $25 or less or increased to $250,000,000 or more. Also, the first player may continue writing or tracing 1 or 2 dashed lines from the previous time the first player wrote or traced 1 or 2 dashed lines on transparency game sheet 103a.

After the first player utilizes the writing instrument 105 to write the dashed line between the dots on transparency sheet 103a, then there is a determination at 507 if the dashed lines between the dots traced by the writing instrument 105 has been formed around 4 boxes around amounts of money $250,000 that add up to $1 million to win the game. If the aforementioned 4 boxes are formed, then the game ends at 509 and the first player wins the game. If the required boxes are not written or traced on the transparency game sheet 103a, by the writing instrument 105, then the game continues and the second player is allowed to play at 511.

At 511, a second player rolls or tosses the first die 109 to determine how many dash lines he can write or trace, utilizing writing instrument 105, between dots on transparency game sheet 103a. In an alternative embodiment, the player may spin first wheel device 113 to determine the number of dash lines he can trace utilizing the writing instrument 105 between the dots on transparency game sheet 103a. At 513, the second player may roll a 0 with first die 109 this indicates that the second player doesn't move at all and the first player is allowed to play at 501.

At 515, the second first player may roll a 1 or 2 with first die 109, then he utilizes writing instrument 105 to write or trace 1 or 2 dashed lines between dots on transparency game sheet 103a horizontally or vertically from anywhere on the first row or last row of horizontal lines depending on where the second player is located in relation to the board game 101. Also, he may continue writing or tracing 1 or 2 dashed lines from the last time he rolled the die 109. The second player traces the dashes between the lines to try and form a box around the monetary value of $250,000 for four times to add up to $1 million to win the game.

After the second player utilizes the writing instrument 105 to write the dashed line between the dots on transparency game sheet 103a, then there is a determination at 517 if the dashed lines between the dots traced by the writing instrument 105 has formed 4 boxes around the monetary value of $250,000 to add up to $1 million to win the game. In this example, four boxes having a monetary value of $250,000.00 need to be in a box to add up to $1 million to win the game. Even though, the monetary value utilized is $250,000 this value can be increased to $251,000 or more or it can be decreased to $249,000 or less. If either of the aforementioned boxes is formed, then the game ends and the second player win the game at 519. If the required boxes are not traced on the transparency sheet 103a of the writing instrument 105 then the game continues and the first player continues at 501.

When the first or second player is able to complete tracing a box by utilizing writing instrument 105 on transparency game sheet 103a, to form boxes around the numbers or numerals $250,000 and combined to form 1 million then the board game is completed. In another embodiment, the first or second player may include their initials or any mark to indicate they have completed a box in order to keep track of their boxes.

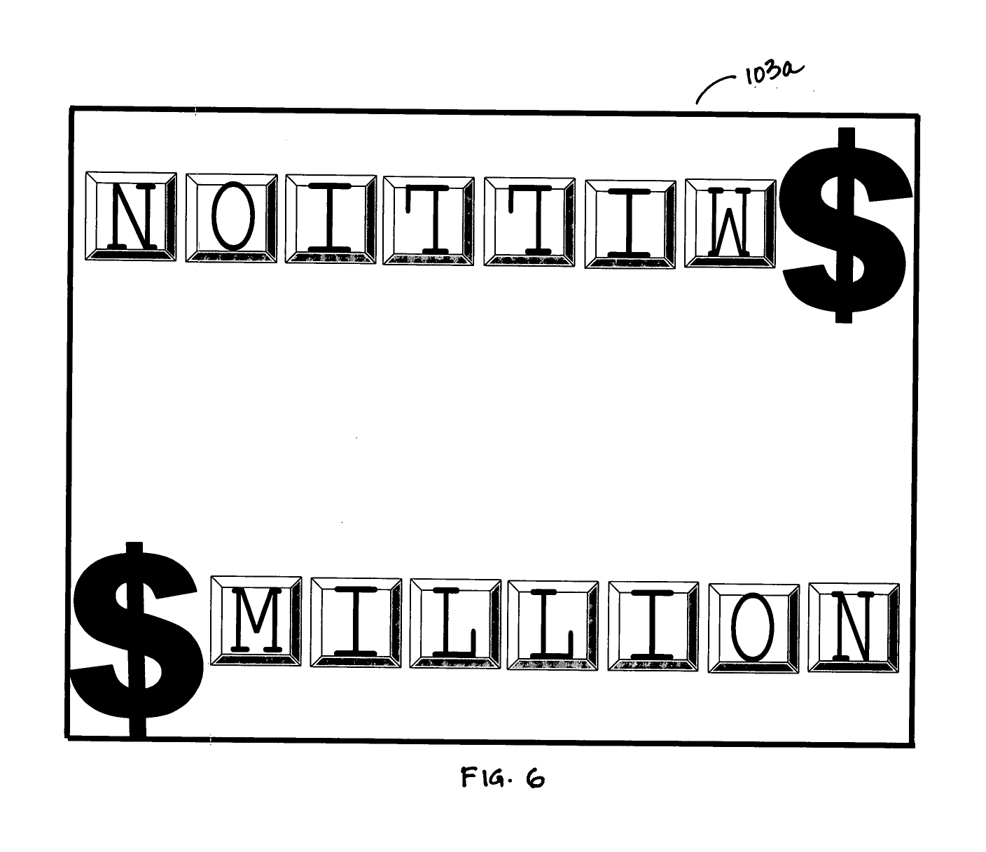

FIG. 6 depicts another embodiment of the transparency game sheet 103a in accordance with an embodiment of the invention. For this version of the transparency game sheet 103a on the top and bottom horizontal portion includes the numerals $, M, I, L, L, I, O and N, where numerals M, I, L, L, I, O and N are in boxes. For this game, the die 111 is used by either player so that when the players roll the die 111 a numeral M, I, L, O or N lands on the top face to indicate the box that the player should mark off with the writing instrument 105. In an alternative embodiment, either player may utilize second wheel device 115, which includes numerals $, M, I, L, O, N, by spinning it until it stops by employing stopper 115a and spinning flexible tab 115a to stop, on one of the numerals, $, M, I, L, O and N. The player would then mark off with the writing instrument 105 on the top or horizontal portion of transparency game sheet 103a, which numeral stopper 115a or spinning flexible tab 115a stopped at. Each player would roll die 111 or spin the second wheel device 115 until a player is able to mark the entire top or bottom horizontal portion of transparency sheet where they would win the game.

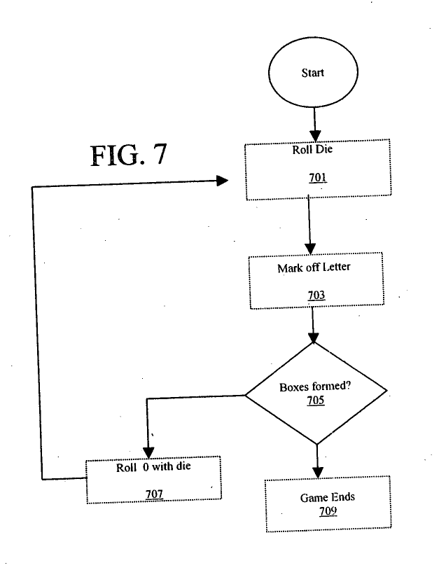

FIG. 7 is a flow chart that shows how the board game of FIG. 6 may be utilized in yet another embodiment of the invention. At 701, a first player rolls or tosses the second die 111 to determine which numeral the player will mark off, at 703, on the top or bottom horizontal portion of transparency game sheet 103a. The player will utilize the writing instrument 105 to make a mark on the transparency game sheet 103a. In an alternative embodiment, the first player may spin the second wheel device 115 with the stopper 115a to stop on a numeral $, M, I, L, O and N that the player will mark on transparency game sheet 103a. In this embodiment, second die 111 will be used interchangeably with second wheel device 115. This marking is a method for using the writing instrument 105 to indicate a specific box on transparency game sheet 103a was completed by a specific player, for example the player can mark his completed box with his initials or any other indicia he chooses.

At 705, there is a determination if the player has marked off all the boxes on the top or lower horizontal portion of transparency sheet 103a. If it is determined that all the boxes have not been marked off, then at 707 the next player tosses the die 111 or spins wheel device 115 returning this process to 701. If it is determined that all the boxes have been marked off then the game is over at 709 and the player who was the first to mark off all his boxes has won the game.

This invention provides a board game that includes a plurality of games that are enjoyable, simple and fun to use. This board game allows a plurality of players to quickly switch from one game to another on the same game board. Further, this invention provides a fun board game that can be used by a plurality of players.

It is intended that the foregoing detailed description be regarded as illustrative rather than limiting and that it be understood that it is the following claims, including all equivalents, which are intended to define the scope of the invention.

1. A board game comprising:
a display screen:
a transparency game sheet disposed above the display screen, wherein the transparency game sheet includes a plurality of games;
a display holder configure to hold the transparency game sheet on top of the display screen;
a writing instrument disposed next to the display screen; and
an arm affixed to the transparency sheet, wherein the arm is configured to move the transparency sheet over the display screen.

2. The board game of claim 1, wherein the writing instrument is configured to mark the display screen.

3. The board game of claim 2, wherein the arm is configured to rotate.

4. The board game of claim 3, wherein the rotating arm is configured to rotate the transparency sheet over the display screen.

5. The board game of claim 1, wherein the display screen is a magnetic screen.

6. The board game of claim 1, wherein the writing instrument is a magnetic pen.

7. A method for playing a board game:
initiating a game;
determining what move to make based on initiating the game; and
determining if based on the move made if the game is finished.

8. The method of claim 7, wherein initiating the game further comprises rolling a die.

9. The method of claim 7, wherein initiating the game further comprises moving a wheel device.

10. The method of claim 9, wherein moving a wheel device further comprises spinning a wheel device.

11. The method of claim 7, wherein determining what move to make based on the initiated game further comprises employing a writing instrument.

12. The method of claim 11, further comprising employing the writing instrument to write between a plurality of dots on a transparency game sheet.

13. The method of claim 12, further comprising writing between the plurality of dots on the transparency game sheet to form a box.

14. The method of claim 13, further comprising forming a plurality of boxes to win a game.

15. A method for playing a board game;
initiating a game;
marking off a letter in the game; and
determining if based on the mark made if the game is finished.
